(19) United States
(12) Patent Application Publication
(10) Pub. No.: US 2006/0157458 A1
(43) Pub. Date: Jul. 20, 2006

(54) Methods for attaching x-ray tube components

(76) Inventor: Don Warburton, West Jordan, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/039,045

(22) Filed: Jan. 20, 2005

(51) Int. Cl. B23K 1/002

(52) U.S. Cl. 219/129

(57) ABSTRACT

A method for bonding components of a device, such as an x-ray tube, is disclosed. The method enables a secure bond to be formed between two or more components without the use of fusion welding or furnace heating techniques, which input excessive quantities of heat into the components to be joined, resulting in heat-related component failure. In one embodiment, surfaces defining an interface between first and second components are cleaned to remove any oxidation. The interface is then locally heated by an electric arc provided by an arc welding torch. Heat that is input by the arc into the interface region is not sufficient to melt the components. Then, a braze material is introduced into the interface. Heat absorbed by the components in the interface region is then transferred to the braze material, which melts and fills the interface region to bond the first and second components together.

### BACKGROUND

1. Technology Field

The present invention generally relates to x-ray tubes and x-ray tube devices. In particular, the present invention relates to methods for attaching x-ray tube components to one another without a resulting compromise in the integrity of the components so bonded.

2. The Related Technology

X-ray generating devices are extremely valuable tools that are used in a wide variety of applications, both industrial and medical. For example, such equipment is commonly employed in areas such as medical diagnostic examination and therapeutic radiology, semiconductor fabrication, and materials analysis.

Regardless of the applications in which they are employed, most x-ray generating devices operate in a similar fashion. X-rays are produced in such devices when electrons are emitted, accelerated, then impinged upon a material of a particular composition. This process typically takes place within an evacuated x-ray tube located in the x-ray generating device. A cathode having an electron source is disposed within the x-ray tube, as is an anode that is oriented to receive electrons emitted by the electron source. The anode, which typically comprises a graphite substrate and a heavy metallic target surface, can be stationary within the tube or can be in the form of a rotating disk supported by a rotor assembly that includes a bearing assembly and a support shaft.

In operation, an electric current is supplied to the electron source of the cathode, causing it to emit a cloud of electrons by thermionic emission. A high electric potential placed between the cathode and anode causes the electron stream to gain kinetic energy and accelerate toward the target surface of the anode. Upon approaching and striking the target surface, many of the electrons convert their kinetic energy and either emit, or cause the target surface material to emit, electromagnetic radiation of very high frequency, i.e., x-rays. The specific frequency of the x-rays produced depends in large part on the type of material used to form the anode target surface. Target surface materials having high atomic numbers (“Z numbers”), such as tungsten carbide or tantalum carbide, are typically employed. The x-rays are then collimated such that they exit the x-ray device through a window in the tube before penetrating an x-ray subject, such as a medical patient during a CT scan.

Successful construction of an x-ray tube for operation as described above often depends upon reliable bonding between various tube components. For instance, the rotor assembly, together with its accompanying bearing assembly, includes several significant component attachment configurations. In addition, components located within the cathode assembly and the anode assembly include other areas where reliable attachments between components are necessary.

Several attachment methods for attaching tube components to one another exist in the art. These known attachment methods include traditional welding and furnace brazing processes. In a welding procedure, two components that are to be joined are heated at a component interface so as to cause melting of one or both components. While in this state, the parts are joined together then allowed to fuse to one another. This process typically includes the use of a welding torch to provide the heating necessary to melt the components at the interface.

Welding carries with it some undesirable consequences. For example, welding can result in excessive heating of the components to be joined. Though heat is directed at the component interface by the torch during the welding process, significant quantities of heat are unavoidably conducted to the entire component. Such global heating can cause problems such as cracking, fatigue, and premature failure of the joined components. In addition, various components used in an x-ray tube sometimes cannot be acceptably welded using traditional techniques. For instance, components comprising tantalum, tungsten, and titanium-zirconium-molybdenum alloys, are not easily joined using fusion welding techniques.

Another method that has been employed in joining tube components is known as furnace brazing. In furnace brazing, components to be joined are placed in a controlled heating environment, such as a vacuum or hydrogen furnace, in order to avoid any oxidation effects. The components are furnace heated, then brazed together by use of a braze alloy that is melted between an interface of the two components.

Furnace brazing also suffers from various disadvantages. One disadvantage involves the fact that the entirety of each component is needlessly and significantly heated by virtue of their placement in the furnace. Again, this significant heat input can alter component properties and result in cracking, fatigue, premature component failure, and undesired separation of the joined components.

Moreover, some x-ray tube components to be joined are necessarily located in close proximity to heat sensitive components that cannot withstand the elevated temperatures produced by furnace brazing. For instance, the bearing assembly that is located in the rotor assembly of the x-ray tube contains multiple sets of ball bearings. Certain bearing sets cannot withstand temperatures exceeding approximately 400° C. However, the braze materials used in furnace brazing typically melt at temperatures exceeding approximately 1050° C. Hence, damage from temperatures exceeding the threshold temperature of the ball bearing sets can be the unfortunate result. This complicates bonding procedures for components located in or near the bearing assembly and/or the ball bearing sets.

Other challenges exist with presently known bonding techniques for x-ray tube components. One of these challenges is the fact that some components to be bonded to one another are often metallurgically incompatible with one another, sometimes making fusion welding and furnace brazing unavailable as bonding options. These and other factors can represent significant challenges when bonding of tube components is considered.

In light of the above discussion, a need exists for a reliable means by which x-ray tube components and the like can be bonded to one another. In particular, a need has arisen for an acceptable bonding technique for use in bearing assemblies where traditional component bonding techniques that employ global, intense heating of the components to be bonded are not available. Any solution to the above should desirably be applicable to a variety of component bonding scenarios within the x-ray tube, or a smaller environment. Further, any solution that does not involve the use of complex apparatus or techniques would be additionally desirable.

### BRIEF SUMMARY OF EXAMPLE EMBODIMENTS

The present invention has been developed in response to the above and other needs in the art. Briefly summarized, embodiments of the present invention are directed to methods for bonding components of a device, such as an x-ray tube. Illustrated methods enable a secure bond to be formed between two or more components without the use of fusion welding or furnace heating techniques. This avoids the introduction of excess heat into the components to be joined, which can result in heat-related component failure.

In one exemplary embodiment, a method for bonding a first component to a second component in an x-ray tube is disclosed. The method includes heating a portion of an interface defined by the first and second components in a non-oxidizing environment to a pre-determined temperature. Preferably, this heating occurs in a manner so as to avoid substantially heating portions of the components outside of the interface region. This is done to minimize heat induced stresses in other areas of the components to be joined. Next, a braze material is applied and melted at the heated interface portion such that the braze material forms a bond between the first and second components.

In an example embodiment, the surfaces that define the interface between the first and the second components are cleaned to remove any oxidation. Also, by way of example, the interface can be locally heated by way of an electric arc provided by an arc welding torch, or by any other suitable means that applies heat directly to the bond interface region. Preferably, the heat that is applied into the interface region should not reach a level that would melt, or otherwise stress or damage the components that are to be joined.

By way of example, the disclosed bonding methodology can be used for bonding components within a x-ray tub rotor assembly. Of course, the bonding technique disclosed can be used to join other components as well, such as a bearing disk to a rotor hub in a rotor assembly is disclosed, or any other components needing a reliable bond.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a cross sectional simplified view of an x-ray tube that serves as one exemplary environment in which principles of the present method can be practiced;

FIG. 2 is a partially exploded view of a portion of a the x-ray tube shown in FIG. 1, depicting a portion of a rotor assembly that includes a bearing assembly;

FIG. 3A is a top view of a bearing disk taken along the line 3A-3A of FIG. 2 showing various details thereof;

FIG. 3B is a top view of a rotor hub taken along the line 3B-3B of FIG. 2 showing various details thereof;

FIG. 4A is a close up cross sectional view of a portion of the rotor assembly of the x-ray tube in FIG. 1, showing one stage in the present method according to one embodiment;

FIG. 4B is a cross sectional side view of the rotor assembly of FIG. 4A, showing another stage in the present method according to one embodiment;

FIG. 4C is a cross sectional side view of the rotor assembly of FIG. 4A, showing a resultant configuration of the rotor assembly according to practice of the present method according to one embodiment; and

FIG. 5 is a simplified cross sectional view of an x-ray tube, illustrating further details of one embodiment of the present invention.

### DETAILED DESCRIPTION OF EXEMPLARY EMBODIMENTS

Reference will now be made to figures wherein like structures will be provided with like reference designations. It is understood that the drawings are diagrammatic and schematic representations of exemplary embodiments of the invention, and are not limiting of the present invention nor are they necessarily drawn to scale.

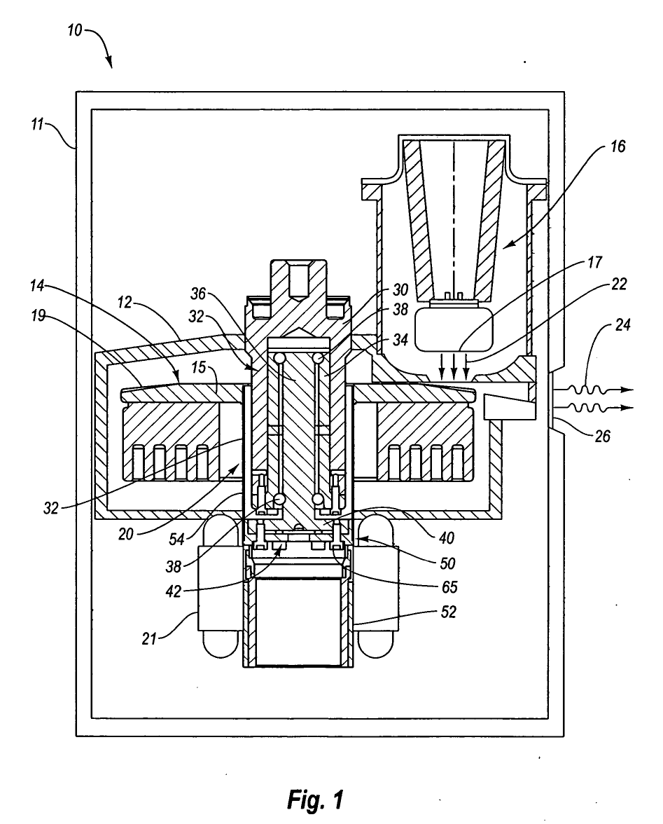

FIGS. 1-5 depict various features of example embodiments of the present invention, which is generally directed to methods for attaching components of an x-ray tube. Tube component bonding according to embodiments of the present method is accomplished while avoiding various undesirable consequences that can result from using other known methods. In addition, the present method for attaching tube components can be employed in portions of the x-ray tube where traditional joining methods are not traditionally effective. Moreover, the methods to be discussed herein utilize no complex apparatus or processes, thereby reducing impact to the overall tube manufacturing method and associated costs.

Reference will now be made to figures wherein like structures will be provided with like reference designations. It is understood that the drawings are diagrammatic and schematic representations of presently preferred embodiments of the invention, and are not limiting of the present invention nor are they necessarily drawn to scale. Reference is first made to FIG. 1, which illustrates the simplified structure of a rotary anode-type x-ray tube, designated generally at 10. The x-ray tube 10 includes a housing 11 and a vacuum enclosure 12 in which is disposed a rotary anode 14 including a target 15, and a cathode 16 including an electron source such as a filament 17. The target 15 is spaced apart from and oppositely disposed to cathode 16. A focal track 19 is located on the target 15, and the target is rotatably connected to a rotor assembly 20 in such a way as to permit free axial rotation of the target. The target 15 of the anode 14 is caused to rotate within the vacuum enclosure 12 during tube operation by any suitable means, including a stator 21.

The operation of an x-ray tube device is well known. The cathode 16 is connected to an appropriate power source. In addition, a voltage potential is established between the anode 14 and cathode 16. The power source provides an electrical current that passes through the cathode filament 17 to cause a cloud of electrons, designated at 22, to be emitted from the filament by thermionic emission. The high voltage differential between the anode 14 and the cathode 16 causes the electrons 22 to accelerate from the filament 17 toward the target 15, which is continuously rotated by the stator 21. As they accelerate, the electrons 22 gain a substantial amount of kinetic energy. Upon approaching and impacting the focal track 19 of the target 15, the kinetic energy of the electrons 22 is converted to electromagnetic waves of very high frequency, i.e., x-rays. The resulting x-rays, designated at 24, emanate from the target 15 and are then collimated through a window 26 for penetration into an object such as an area of a patient's body. As is well known, the x-rays 24 that pass through the object can be detected, analyzed, and used in any one of a number of applications, such as x-ray medical diagnostic imaging or materials analysis procedures.

It should be noted that the x-ray tube as discussed above serves merely as one exemplary environment in which principles of the present invention to be discussed below can be practiced. Indeed, it is appreciated that x-ray tubes having a variety of configurations and components, above and beyond those discussed explicitly herein, can benefit from the component attachment methods discussed in the embodiments of the present invention. Therefore, the above discussion, as well as the details to follow, should not be considered as limiting of the present invention in any way.

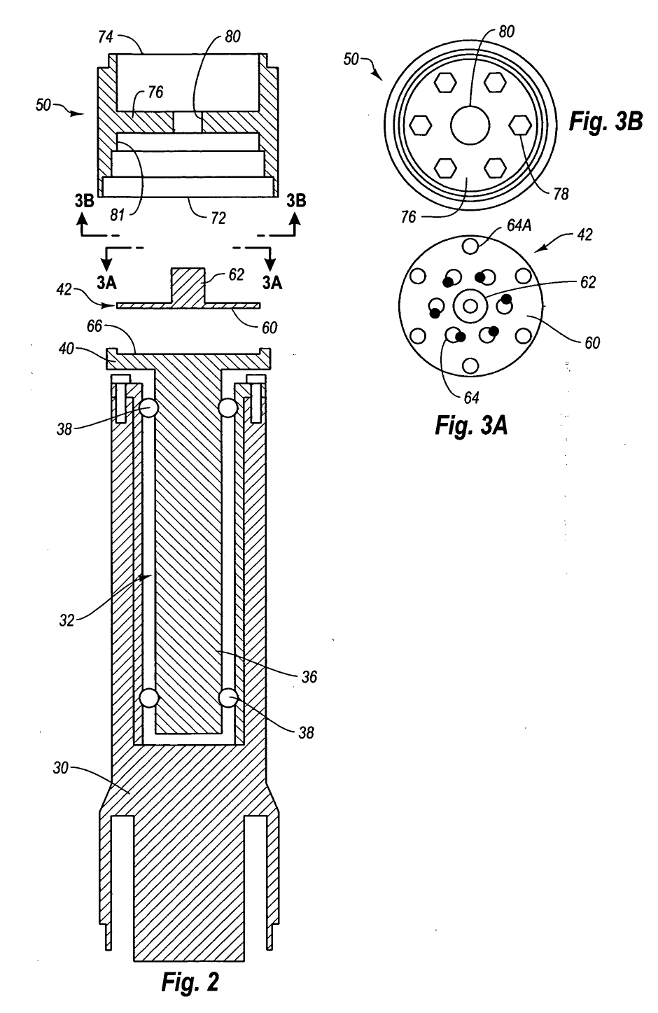

Together with FIG. 1, reference is now also made to FIG. 2, which depicts various details regarding portions of the rotor assembly 20, which is a component of the x-ray tube 10 shown in FIG. 1, in a 180° inverted view with respect to FIG. 1. In detail, FIG. 2 shows an exploded view of portions of the rotor assembly 20. A support stem 30 is included for interfacing with the evacuated enclosure 12 to provide structural support for the anode 14. A bearing assembly 32 is located in a portion of the support stem 30, and includes a bearing housing 34 within which is located a bearing hub 36. The bearing hub 36 is spaced apart from and rotatably connected to the bearing housing 34 via a plurality of ball bearings, some of which are shown at 38. This arrangement enables the bearing hub 36 to rotate with respect to the bearing housing and support stem 30, ultimately providing for rotation of the target 15 of the anode 14.

The bearing hub 36 in the present embodiment includes a head portion 40 extending from the support stem 30 and bearing housing 34. The head portion 40 is configured to attach to a bearing disk 42, more clearly shown in FIG. 2, the details of which are explained below. In one embodiment, the bearing disk 42 is composed of a metallic substance, such as H13 steel, though other compositions are also possible.

FIG. 2 further depicts a rotor hub 50 that is included as yet another component of the rotor assembly 20. As will be described in further detail below, the rotor hub 50 is suitably attached to the bearing disk 42, and is also interposed between a rotor sleeve 52 and an anode cylinder 54 that are attached to the rotor hub. As is known, the rotor sleeve 52 interacts with electromagnetic fields produced by the stator 21 in order to induce rotation of the rotor assembly 20 via a motive force. The anode cylinder 54 interconnects with the target 15 of the anode 14 to enable rotation of the target via the rotor assembly 20 and the motive force provided by the stator 21 during x-ray tube operation. As such, the rotor hub 50, being interconnected with the rotatable bearing hub 36, is an integral component of the rotor assembly 20 in enabling target rotation during x-ray tube operation. In one embodiment, the rotor hub 50 is composed of an alloy material including titanium, zirconium, and molybdenum, commonly known as “TZM,” though in other embodiments other materials may also be acceptably used.

Together with FIGS. 1 and 2, reference is now also made to FIGS. 3A and 3B, depicting various details of both the bearing disk 42 and rotor hub 50. In particular, FIG. 3A depicts a top view of the bearing disk 42, which includes a disk portion 60 integrally formed with a-central cylinder portion 62. As shown, the disk portion 60 includes various holes 64 annularly defined about the cylinder portion 62. At least some of an outer set of holes 64A can be used for receiving screws, such as screws 65 shown in FIG. 1, for use in securing the bearing disk 42 to the bearing hub 36.

As shown, the head portion 40 of the bearing hub 36 includes a circular recess 66 that is shaped and configured to receive the disk portion 60 of the bearing disk 42 therein, thereby providing secure engagement of the bearing disk with the head portion.

FIG. 3B, together with FIG. 2, shows various details regarding the rotor hub 50. In particular, the rotor hub 50 includes a notched first end 72 that is configured for engaging the anode cylinder 54 (FIG. 1), and a notched second end 74 that is configured to engage the rotor sleeve 52 (FIG. 1). In addition, the rotor hub 50 includes an interior disk 76 having a plurality of annularly arranged holes 78 defined therethrough. The holes 78 are configured for receiving the screws 65 discussed above when the rotor hub 50 is attached to the bearing disk 42 and head portion 40 of the bearing hub 36. Also, the interior disk 76 includes a central hole 80 that is configured to receive the cylinder portion 62 of the bearing disk 42. A recess 81 is defined by the rotor hub 50 adjacent the interior disk 76 that is sized and configured to receive the disk portion 60 of the bearing disk 42. The various engagements outlined above between the rotor hub 50 and the bearing disk 42 are described in further detail below in connection with one embodiment of the present invention.

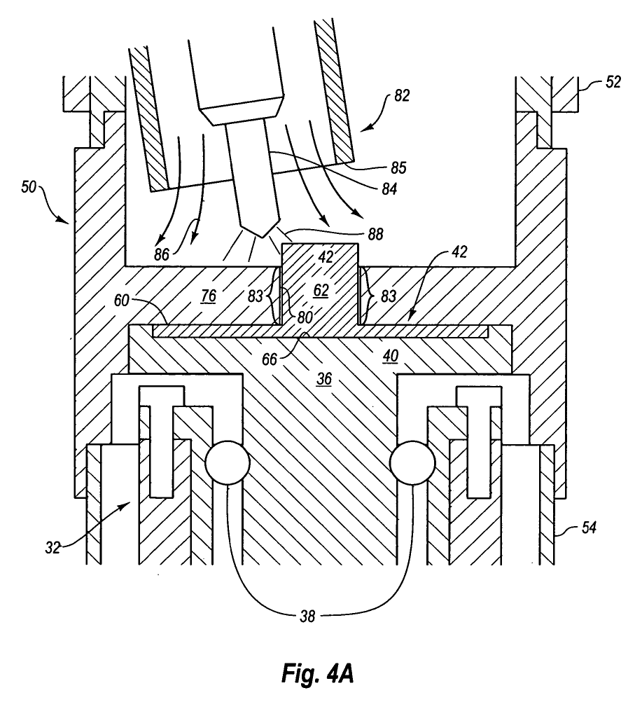

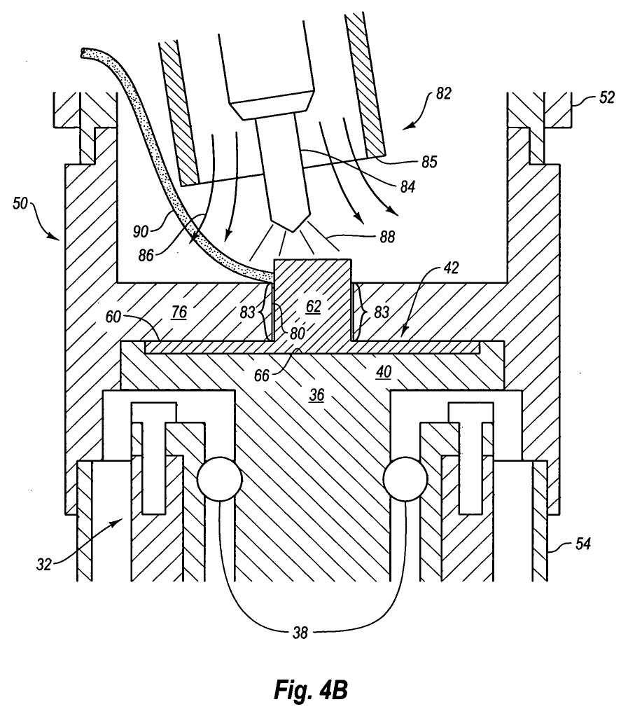

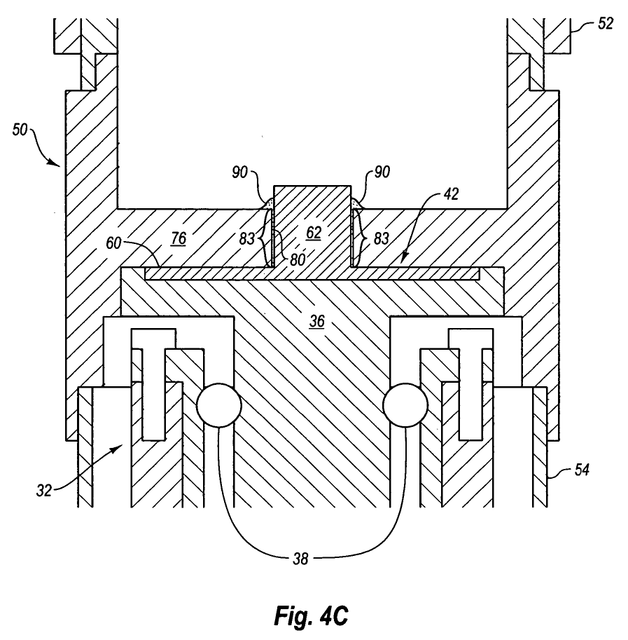

Reference is now made to FIGS. 4A-4C, which depict details regarding one embodiment of a method for joining x-ray tube components. In particular, FIG. 4A shows portions of the rotor assembly 20, including the bearing assembly 32, in an assembled condition within the x-ray tube 10 (FIG. 1). In detail, the bearing disk 42 is shown received into the recess 66 of the bearing hub 36, and the rotor hub 50 is positioned so as to receive within its central hole 80 the cylinder portion 62 of the bearing disk 42. The engagement of the rotor hub 50 with the bearing disk 42 facilitates rotation provided by the bearing assembly 32 to extend to other components of the rotor assembly 20, including the rotor sleeve 52 and the anode cylinder 54. As such, a secure bonding between the rotor hub 50 and the bearing disk 42 is necessary in ensuring proper functionality of the rotor assembly 20 during x-ray tube operation.

In accordance with one example embodiment, a method is disclosed for bonding components within a device, such as an x-ray tube. In the illustrated embodiment of FIGS. 4A-4C, this enables bonding of the rotor hub 50 to the bearing disk 42 in a secure arrangement that prevents compromise of either the components or the integrity of the bond therebetween. Before the bonding method is commenced, the various components are assembled as shown in FIG. 4A, wherein the rotor hub 50 is positioned so as to receive in its central hole 80 the cylinder portion 62 of the bearing disk 42. At the time of placement of the rotor hub 50 onto the bearing disk 42, the rotor hub can have already affixed thereto various other components shown, such as the rotor sleeve 52 and anode cylinder 54, though in other embodiments these parts can be attached at a later time. Also, in the present embodiment, the bearing disk 42 has previously been affixed in the recess 66 of the bearing hub head portion 40.

In the initial assembled state shown in FIG. 4A, an interface, generally denoted at 83, is defined between the cylinder portion 62 of the bearing disk 42 and the portion of the rotor hub 50 defining the hole 80. The interface 83 therefore defines a region in which bonding between the bearing disk 42 and the rotor hub 50 is to occur. More generally, an interface will be defined between any two components to be joined by this method, and as such, the interface will vary according to the components to be joined, depending on the particular application. Thus, in the embodiment shown in FIG. 4A, the interface 83 is a cylindrically-shaped region defined by the outer surface of the cylinder portion 62 of the bearing disk 42 and the inner surface of the portion of the rotor hub 50 defining the central hole 80, wherein a small gap exists between these surfaces.

In a first stage of the method, the interface 83 defined by the bearing disk 42 and rotor hub 50 are cleaned in order to eliminate surface oxidation. Such cleaning to remove oxidation can occur either before or after the rotor hub 50 is assembled with the bearing disk 42 as shown in FIG. 4A. Again, in one embodiment, the rotor hub 50 is composed of TZM, while the bearing disk 42 is composed of H13 steel, though in other embodiments other material compositions are also possible.

In a second stage of the method, a heat source is introduced to provide necessary component interface heating. In one embodiment, the heat source is selected so as to provide intense localized heating proximate a portion of the interface 83 in preparation for bonding of the rotor hub 50 to the bearing disk 42. Heating of these components is limited to the localized region of the interface 83 in order to avoid the problems common with known bonding techniques, which techniques heat the entirety of the components to be bonded as well as other adjacent portions of the rotor assembly or x-ray tube. As has been discussed, this generalized heating of the components and surrounding region can adversely affect not only the components themselves, i.e., fatigue and heat cracks, especially in refractory metals such as TZM, molybdenum, tungsten, etc., but other heat sensitive areas as well such as the ball bearings 38 of the bearing assembly 32 (FIG. 4A) in the present case.

In one embodiment, localized heating in accordance with the present method is provided by an electric arc device, such as a gas tungsten arc welding (“GTAW”) torch, generally designated at 82 in FIG. 4A. As shown, the GTAW torch 82 (also known as a tungsten inert gas (“TIG”) torch) includes an electrode 84 extending from a first end 85 of the torch: The first end 85 is open so as to define a port through which a flow of gas 86 passes about the electrode 84. In one embodiment, the electrode 84 is composed of tungsten, while the gas 86 is argon, though in other embodiments, the electrode and gas or other suitable fluid can be composed of other components. The GTAW torch 82 produces an arc, designated at 88, between the electrode 84 and a grounded workpiece. The arc 88 provides a source of intense heating that is necessary for the present bonding method, as will be shown.

FIG. 4A shows that in the second stage of the present method, the GTAW torch 82 is brought into close proximity with the components to be bonded, in this case the rotor hub 50 and bearing disk 42. The rotor hub 50 and bearing disk 42 are grounded, and the GTAW torch 82 is activated so as to strike the arc 88 between the electrode 84 and the components. The tip of the electrode 84 is directed along a portion of the interface 83 in a manner sufficient to provide localized heating of the rotor hub 50 and bearing disk 42 in the interface region to a pre-determined temperature. As mentioned, the flow of gas 86 surrounds the arc 88 during this stage so as to prevent oxidation from forming at or near the interface 83.

Note that the arc 88 locally heats the portion of the interface 83 to a predetermined temperature that is sufficient to provide heat for further process steps as will be described below, but that is insufficient to melt any portion of the rotor hub 50 or bearing disk 42. Note also that the movement of the GTAW torch 82 is such that the heated portion of the interface 83 remains under the flow of gas 86 until bonding is complete, thereby preventing oxidation at or near the interface during the bonding process. In some cases, one of the components to be bonded may have a higher melting temperature than another component to be bonded thereto. In this case, the arc 88 of the GTAW torch 82 should be directed for contact with the component having the higher melting temperature so as to prevent undesired melting of the component having the lower melting temperature.

In accordance with the above, it is seen that in one embodiment the GTAW torch 82 provides the intense localized heating for the present method. It is appreciated, however, that in other embodiments other localized heat sources can be employed. One example of an alternative localized heat source is an electric arc device known as a plasma arc welding (“PAW”) torch. Another possible localized heat source is a laser having a surrounding gas flow. Also, though the GTAW torch shown in FIG. 4A is configured as explained above, in other embodiments the GTAW torch may have a design that varies from that explicitly described herein.

Particular reference is now made to FIG. 4B, showing a successive stage of the present method according to one embodiment. In a third stage, once a portion of the interface 83 is sufficiently heated a braze material 90 is fed in and placed adjacent to the heated portion of the interface 83. In one embodiment, the braze material 90 is in the form of a flexible wire that can be fed into the location of the heated interface portion. In other embodiments, it is possible to pre-shape a mass of brazed material corresponding to the shape of the heated interface portion, and place it at the heated interface portion.

The braze material 90 is introduced to the heated interface portion 83 once the arc 88 has been removed, but before the flow of gas 86 is removed in order to prevent oxidation at the interface portion. Then, the heat that has been absorbed by the rotor hub 50 and bearing disk 42 at the heated portion of the interface 83 during heating by the arc 88 of the GTAW torch 82 is transferred to the braze material positioned at the interface. This prior heating enables a quantity of heat to transfer from the portions of the rotor hub 50 and the bearing disk 42 proximate the heated portion of the interface 83 sufficient to cause melting of the braze material 90 at the heated portion of the interface. In this way, a quantity of heat exceeding the melting temperature of the braze material 90 is indirectly delivered to the braze material. This in turn causes a flow of melted braze material 90 to enter the gap at the portion of the interface 83 existing between the rotor hub surface defining the hole 80 and the outer surface of the cylinder portion 62, assisted by capillary action. Upon further dissipation of the heat, the braze material 90 that has entered the gap will resolidify and create a secure bond between the rotor hub 50 and the bearing disk 42. As mentioned, this process is performed under the flow of gas 86 so as to prevent oxidation on the bonding surfaces during the process.

The above process is continued as the arc 88 is moved along the interface 83, heating successive portions of the interface then melting the braze material 90 at the interface portion. This enables a complete braze bond to form along the entirety of the interface 83 as proper heating of each interface portion is achieved.

In one embodiment, the braze material is composed of a product sold under the trademark NICORO™, which is an alloy containing gold, copper, and nickel. In other embodiments, however, the braze material can be composed of copper, gold, or other suitable materials. In general, some desirable qualities of the braze material in one embodiment include a melting temperature that is below that of the components to be bonded, good wetting properties with respect to the components to be bonded, ductility of the brazing material after the bonding process is complete so as to enable the braze to act as a stress reliever on the bond interface, good oxidation properties, and metallurgical compatibility with the components to be bonded. Note that, when bonding one or more components composed of TZM, the nickel content of the braze material should be controlled so as to avoid liquid metal embrittlement after the bonding process is complete, which embrittlement reduces the integrity of the bond.

In an alternative embodiment, the braze material can be preplaced at the interface before interface heating by the arc of the GTAW torch occurs. For example, in FIG. 4B a cylindrical interface 83 is defined between the rotor hub 50 and bearing disk 42 to be bonded to one another. In this case, a preformed annular ring of braze material can be placed at the top of the interface 83 about a top portion of the bearing disk cylinder portion 62. Heating of the rotor hub 50 and/or the bearing disk 42 near the interface 83 can then proceed in order to melt the braze material as described above. However, it is important in such an instance to avoid heating the braze material directly so as to prevent problems with balling up of the braze material, thereby preventing soak-in of the braze material into the gap between the cylinder portion 62 and the central hole 80 due to surface tension. Again, as before, it should be remembered that the heating provided by a heat source such as the GTAW torch should be monitored to provide sufficient heat to enable melting of the braze material while limiting heating so as to prevent melting of the components to be bonded.

Reference is now made to FIG. 4C which depicts the rotor hub 50 and bearing disk 42 after bonding. As shown, the rotor hub 50 is bonded to the bearing disk 42 at the interface 83 via the braze material 90 that was melted and resolidified per the above discussion. As such, the braze material has substantially filled the cylindrical interface 83 existing between the rotor hub hole 80 and the bearing disk cylinder portion 62. The result is a high strength bond between the rotor hub 50 and bearing disk 42 that secures the position of these parts with respect to one another, especially during rotation of the rotor assembly 20 (FIG. 1) during x-ray tube operation.

As mentioned, the composition of the braze material 90 can be selected such that it remains ductile even after hardening, thereby providing some stress relief on the bond interface. Also, as was described, the braze material 90 is melted by heat emanating from the components to be bonded, in this case, the rotor hub 50 and the bearing disk 42 proximate the interface 83. In allowing the braze material to be melted by heat coming from the components to be bonded, as opposed to directly heating the braze material at the interface, good wetting properties for the braze material are preserved, which allows the braze material to infiltrate the gap between the rotor hub hole 80 and the bearing disk cylinder portion 62, thereby creating a superior braze-to-component adhesion. Further, the structural properties of the components to be bonded remain substantially unaffected because intense global heating and melting of these components is avoided.

In one embodiment, it may be desirable to perform more than one brazing operation on an interface between components to be bonded. In this case, oxidation removal between bonding procedures should be used in order to maximize the bonding effectiveness of the braze material. In addition, though the present discussion has focused on the bonding of two components to one another, it is possible that three or more components can be bonded to one another, either simultaneously or in succession, using embodiments of the present method.

As mentioned, the above method for bonding the rotor hub to the bearing disk is performed without the use of a controlled or heated atmosphere such as a furnace, thereby reducing manufacturing expense. In one embodiment, the method for joining these components can also be practiced in a non-heated, non-oxidizing environment, such as a hydrogen atmosphere environment.

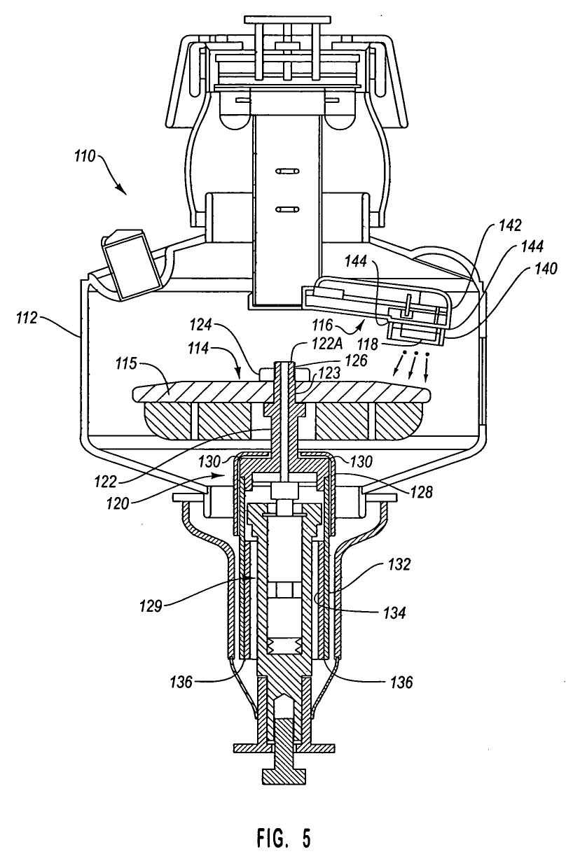

Reference is now made to FIG. 5. It is appreciated that, in other embodiments, the present invention can be employed in bonding components in areas of an x-ray tube other than that shown in FIGS. 2-4C. FIG. 5 depicts various examples of this principle. In particular,. FIG. 5 depicts an x-ray tube generally designated at 110 and including an evacuated enclosure 112. The evacuated enclosure 112 contains an anode 114 having a target 115, and a cathode 116 oppositely positioned with respect to the target. The anode 114 is rotatably mounted to a rotor assembly 120 to enable rotation of the anode during tube operation.

The rotor assembly 120 includes various components that can be joined using principles of embodiments of the present invention. For example, in one embodiment, the rotor assembly 120 includes a rotor shaft 122 having an end 122A that extends through a hole 123 defined in the target 115. The end 122A of the rotor shaft is configured to threadingly engage with a nut 124 in order to secure the target 115 on the rotor shaft end. One embodiment of the present method can be used to bond the nut 124 to the rotor shaft 122 proximate the end 122A thereof. This bonding can be accomplished in one embodiment by applying a braze material about an annular braze point 126, shown in FIG. 5, in manner similar to that described above in connection with FIGS. 4A-4C. In this way, the nut 124 can be securely fastened to the rotor shaft 122, thereby preventing loosening of the nut and ensuring a secure affixation of the target 115 in its proper position within the evacuated enclosure 112.

In another embodiment, other components of the rotor assembly 120 can be bonded using the method as described herein. In particular, a heat shield 128 is positioned over a portion of the rotor shaft 122 in order to prevent the transmission of excessive quantities of heat to other portions of the rotor assembly, such as a bearing assembly 129, thereby avoiding degradation of the ball bearings and other heat sensitive components of the bearing assembly during tube operation. In accordance with one embodiment, the heat shield 128 can be bonded to a portion of the rotor shaft at an annular braze point 130 shown in FIG. 5 using the bonding method as generally described above in connection with FIGS. 4A-4C. This method of bonding the heat shield 128 to the rotor shaft 122 at the braze point 130 enables this connection to be made without the input of large quantities of heat into the rotor assembly 120 during manufacture, thereby desirably preventing heat damage to the bearing assembly 129.

In yet another embodiment, another portion of the rotor assembly 120 can employ principles of the present invention. In particular, a rotor sleeve 132 is shown in FIG. 5 attached to the rotor shaft 122. In addition, an interior sleeve 134 is attached to an inner surface of the rotor sleeve 132. The interior sleeve 134 can be bonded to the rotor sleeve 132 using the method as generally described above in connection with FIG. 4A-4C. In particular, an annular braze point 136 can be used to melt a braze material between the rotor sleeve 132 and the interior sleeve 134 in order to bond the two components together in a secure arrangement. Advantageously, this is accomplished without the input of significant quantities of heat near the bearing assembly 129 and other heat-sensitive components of the rotor assembly 120. Accordingly, this and the other locations described above are exemplary of locations within the rotor assembly 120 that can benefit from employing the bonding method disclosed in connection with embodiments of the present invention. Thus, these and other suitable bonding locations are contemplated as falling within the claims of the present invention.

In another embodiment, portions of the cathode 116 can be bonded using the method of the present invention. In particular, the cathode 116 includes a cathode head 140 that is attached to a cathode arm 142 in order to position the cathode head properly with respect to the target 115. The cathode head 140 can be bonded to the cathode arm 142 at an annular braze point 144 defined about an interface between these two components using the method as generally discussed above in connection with FIGS. 4A-4C. Thus, bonding of the cathode head to the cathode arm serves as yet another example of the applicability of embodiments of the present invention to a variety of locations within an x-ray tube or x-ray tube-based device. Again, it should be appreciated that a variety of other bonding configurations can benefit from this bonding method, in addition to those explicitly described herein.

It is appreciated that the bond created as a result of the method described herein can be a hermetic or non-hermetic bond, according to need. In addition, various metal combinations of the components to be bonded are possible, including bonding a copper component to steel, bonding a refractory component to various other materials, and bonding TZM to a tungsten component. Other materials, including tantalum, niobium, and other materials that typically do not bond well using fusion welding can be acceptably bonded using the present method. Further, the use of the present method for bonding components can find applicability in environments outside of x-ray tubes as well. Indeed, bonding applications where global heating of the components to be bonded is not possible serve as good candidates for employment of the bonding method as described herein. Moreover, embodiments of the present bonding method can be used to bond metallurgically incompatible components, assuming that a braze material that is individually compatible with each component is used as the bonding medium.

The present invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. In an x-ray tube, a method for bonding a first component to a second component, the method comprising:
heating a portion of an interface defined by the first and second components in a non-oxidizing environment to a pre-determined temperature without heating the entirety of the first and second components to the pre-determined temperature; and
melting a braze material at the heated interface portion in the non-oxidizing environment such that the braze material forms a bond between the first and second components.

2. The method for bonding as defined in claim 1, wherein the non-oxidizing environment is provided by flow of gas about the portion of the interface.

3. The method for bonding as defined in claim 1, wherein melting the braze material further comprises:
melting the braze material from heat absorbed by at least one of the first and second components at the heated interface portion.

4. The method for bonding as defined in claim 1, wherein melting the braze material further comprises:
melting the braze material such that the braze material forms a hermetic bond between the first and second components.

5. The method for bonding as defined in claim 1, wherein the first and second components are included in a rotor assembly.

6. The method for bonding as defined in claim 5, wherein the first component is a bearing disk and the second component is a rotor hub, the bearing disk and rotor hub being positioned proximate portions of a bearing assembly.

7. The method for bonding as defined in claim 5, wherein the first component is a rotor sleeve and the second component is an interior sleeve that is bonded to an inner surface of the rotor sleeve.

8. The method for bonding as defined in claim 5, wherein the first component is a rotor shaft and the second component is a nut that threadingly engages an end of the rotor shaft.

9. The method for bonding as defined in claim 5, wherein the first component is a rotor shaft and the second component is a heat shield that is positioned over a portion of the rotor shaft.

10. The method for bonding as defined in claim 1, wherein the first component is an arm supporting a portion of a cathode assembly, and wherein the second component is a cathode head supported by the arm.

11. The method for bonding as defined in claim 1, wherein the braze material is positioned at the portion of the interface before the portion of the interface is heated.

12. The method for bonding as defined in claim 1, wherein the braze material is pre-formed to correspond to the shape of the interface.

13. A method for bonding components within a rotor assembly, comprising:
cleaning at least a portion of an interface defined by a first rotor assembly component and a second rotor assembly component to remove oxidation at the portion of the interface;
heating the interface portion with an electric arc; and
melting a braze material at the heated interface portion to bond the first rotor assembly component to the second rotor assembly component.

14. The method for bonding as defined in claim 13, wherein heating the interface portion further comprises:
heating the interface portion to a pre-determined temperature with the electric arc, wherein the pre-determined temperature is sufficient to cause melting of the braze material but is insufficient to cause melting of the first and second rotor assembly components.

15. The method for bonding as defined in claim 13, wherein heating the interface portion is insufficient to cause heat damage to components of a bearing assembly of the rotor assembly, the bearing assembly including ball bearing sets.

16. The method for bonding as defined in claim 13, wherein the first and second rotor assembly components are metallurgically incompatible with one another, and wherein the braze material is compatible with the first and second rotor assembly components.

17. The method for bonding as defined in claim 13, wherein at least one of the first and second rotor assembly components is composed of a material selected from the group consisting of TZM and steel, and wherein the braze material is selected from the group consisting of a product sold under the trademark NICORO™, gold, and copper.

18. The method for bonding as defined in claim 13, wherein the first rotor assembly component is a bearing disk that is attached to a rotatable bearing assembly hub and the second rotor assembly component is a rotor hub that is attached to a rotor sleeve.

19. In a rotor assembly of an x-ray tube, a method for bonding a bearing disk to a rotor hub, the method comprising:
removing oxidation from a portion of an interface defined by the bearing disk and the rotor hub;
by an electric arc, heating the interface portion within a flow of a non-oxidizing gas to a pre-determined temperature that is below the melting temperature of the bearing disk and the rotor hub;
within the flow of the non-oxidizing gas, melting a braze material at the heated interface portion such that the braze material bonds the bearing disk to the rotor hub.

20. The method for bonding as defined in claim 19, wherein melting the braze material further comprises:
melting the braze material at the heated interface portion such that the braze material bonds a cylindrical portion of the bearing disk to a portion of the rotor hub that receives the cylindrical portion.

21. The method for bonding as defined in claim 20, wherein the electric arc is provided by a gas tungsten arc welding torch, and wherein the non-oxidizing gas is argon that is supplied by the gas tungsten arc welding torch.

22. The method for bonding as defined in claim 21, wherein heating the interface portion further comprises:
heating the interface portion to the pre-determined temperature without heating the entirety of the bearing disk and the rotor hub to the pre-determined temperature.

23. The method for bonding as defined in claim 22, wherein heating the interface portion and melting the braze material is repeated with successive portions of the interface until the entire interface is bonded by the braze material.

24. The method for bonding as defined in claim 23, wherein the braze material remains ductile after bonding to relieve stress on the bond created between the bearing disk and the rotor hub.

25. The method for bonding as defined in claim 24, wherein the interface includes a gap between the bearing disk and the rotor hub.
